(19) United States
(12) Patent Application Publication
(10) Pub. No.: US 2016/0183721 A1
(43) Pub. Date: Jun. 30, 2016

(54) Vertical Cooking Charcoal Grill

(71) Applicant: Thayer Fakhuri, Woodland Hills, CA (US)

(72) Inventor: Thayer Fakhuri, Woodland Hills, CA (US)

(21) Appl. No.: 14/488,912

(22) Filed: Sep. 17, 2014

(51) Int. Cl. A47J 37/07

(52) U.S. Cl. CPC A47J 37/0718; A47J 37/0763

(57) ABSTRACT

A vertical barbeque grill comprising a base comprising a bottom and a top surface, a proximate and a distal edge, at least two pairs of supports comprising a first and a second support comprising an upper and a lower portion, the lower portion coupled to the top surface of the base, the supports extend away from and perpendicular to the base, the first support coupled to the proximate edge of the base, the second support coupled to the distal edge of the base, the first pair of supports spaced apart from the second pair of supports, at least one cooking chamber between the two pairs of supports, at least one opening in the base below the cooking chamber, at least two fire material retaining means coupled to the supports, creating at least two fire material chambers, and at least one liquid collection container located below the openings in the base.

### BACKGROUND

Many people enjoy using a charcoal grill to cook their food. This is due in part to the flavor imparted to food that is cooked over charcoal. Many people also enjoy cooking their food outdoors, especially in the summer time when the weather is pleasant. However, there are several disadvantages associated with known charcoal grills. For example, typical charcoal grills require the heat source, and therefore charcoal, to be located beneath the food being cooked. This means that the food is only being cooked on one side at a time. Therefore the cooking time is greater because the food needs to flipped and cooked on both sides.

Additionally, when food is cooked juices and moisture necessarily leave the food. This is especially problematic when the food being cooked is meat. The juices from the meat drip down and fall onto the charcoal below, which results in a large amount of smoke. Smoke is undesirable for many reasons, including but not limited to the fact that is tends to irritate the eyes and throat of the user. Moreover, the smell of the smoke easily permeates the users' clothes and hair, resulting an unpleasant smell lingering long after the user is done using the charcoal grill.

Additionally, due to the fact that the charcoal is beneath the food and the smoke necessarily must rise up and pass the food to escape, the food can be charred by the charcoal. There is a commonly held belief that the charring can be a carcinogen. Therefore, there is a need for an improved charcoal grill that is easy and healthy to use and cooks food efficiently.

The present invention overcomes several of the deficiencies, disadvantages and undesired parameters associated with known charcoal grills.

### SUMMARY

The invention is a vertical barbeque grill comprising a base comprising a bottom surface, a top surface, a proximate edge and a distal edge, at least two pairs of supports comprising a first support and a second support, the pairs of supports comprising an upper portion and a lower portion, wherein the lower portion is coupled to the top surface of the base and the at least two pairs of supports extend away from and are perpendicular to the top surface of the base, wherein the first support is coupled to the proximate edge of the base and the second support is coupled to the distal edge of the base, the first pair of supports is spaced apart from the second pair of supports, at least one cooking chamber disposed in between the two pairs of supports, at least one opening in the base below the at least one cooking chamber, at least two fire material retaining means coupled to the supports, creating at least two fire material chambers, and at least one liquid collection container located below the at least one opening in the base.

In another embodiment, a vertical barbeque grill comprising a base comprising a bottom surface, a top surface, a proximate edge and a distal edge, at least two pairs of supports coupled to the top surface of the base, extending away from and perpendicular to the top surface of the base, wherein the at least two pairs of supports comprise a first support coupled to the proximate edge of the base and a second support coupled to the distal edge of the base, the first pair of supports is spaced apart from the second pair of supports, and at least one cooking chamber disposed in between the two pairs of supports.

Optionally, the base and the at least two pairs of supports are made from metal. Additionally, the vertical barbeque grill can further comprise at least one opening in the base below the at least one cooking chamber.

Optionally, the vertical barbeque grill can further comprise at least one liquid collection container located below the at least one opening in the bottom surface of the base for collecting liquid released from food in the cooking chamber.

The vertical barbeque grill can further comprise at least two fire material retaining means coupled to the at least two pairs of supports, creating at least two fire material chambers. Optionally, the at least two fire material retaining means are removable. Additionally, the at least two fire material retaining means can comprise a mesh. Optionally, the two fire material chambers can be permanently coupled to the top surface of the base.

The at least two pairs of supports comprise an upper portion and a lower portion, and the upper portion comprises at least one slot and the at least two fire retaining means are coupled to the upper portion of the supports by the at least one slot.

Additionally, the vertical barbeque grill can further comprise at least one liquid collection container located below the cooking chamber.

The invention also comprises a method of using the vertical barbeque grill. The method comprises the steps of providing the vertical barbeque grill, coupling the at least two fire material retaining means to the at least two pairs of supports, inserting fire material into the at least two fire material chambers, igniting the fire material to produce a heat source for cooking food, inserting food into the cooking chamber, and cooking the food inside the cooking chamber.

### DRAWINGS

These and other features, aspects, and advantages of the present invention will become better understood with regard to the following description, appended claims, and accompanying drawings.

FIG. 1 is a perspective view of a vertical barbeque grill having features of the present invention.

FIG. 2 is an exploded perspective view of the vertical barbeque grill illustrated in FIG. 1.

FIG. 3 is a perspective view of an additional embodiment wherein multiple vertical barbeque grills have been coupled together.

FIG. 4 is perspective view of the bottom of the multiple vertical barbeque grills illustrated in FIG. 3.

FIG. 5 is a perspective view of the vertical barbeque grill illustrated in FIG. 1, further comprising a searer.

### DESCRIPTION

Definitions

As used herein, the following terms and variations thereof have the meanings given below, unless a different meaning is clearly intended by the contest in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

The term “mesh” used herein refers to “material made of a network of wire or thread; an interlaced structure.”

The Invention

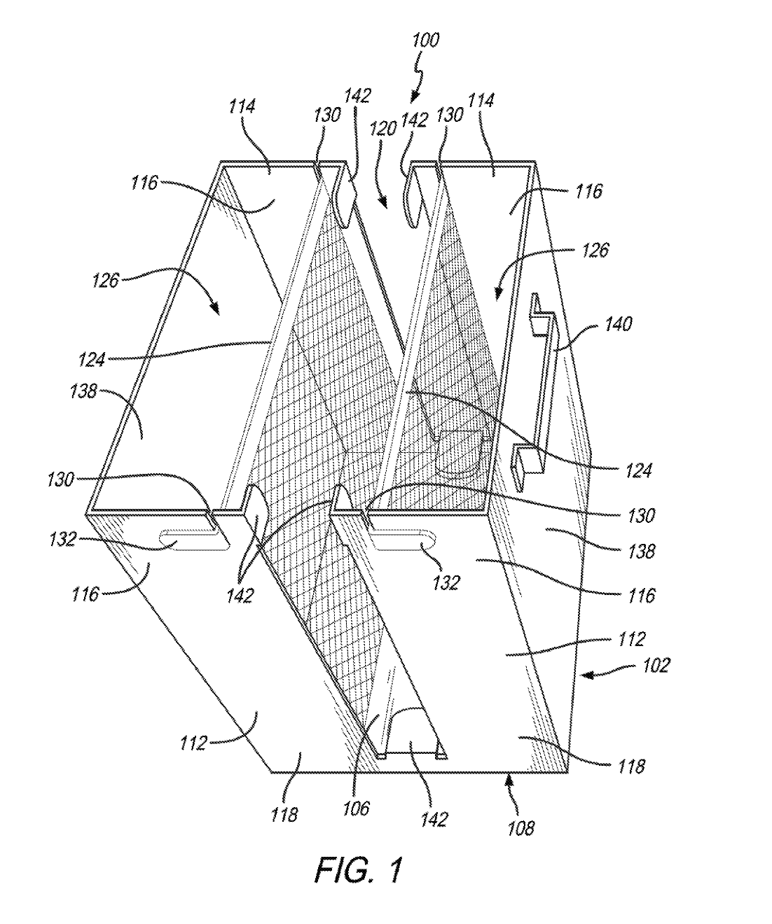

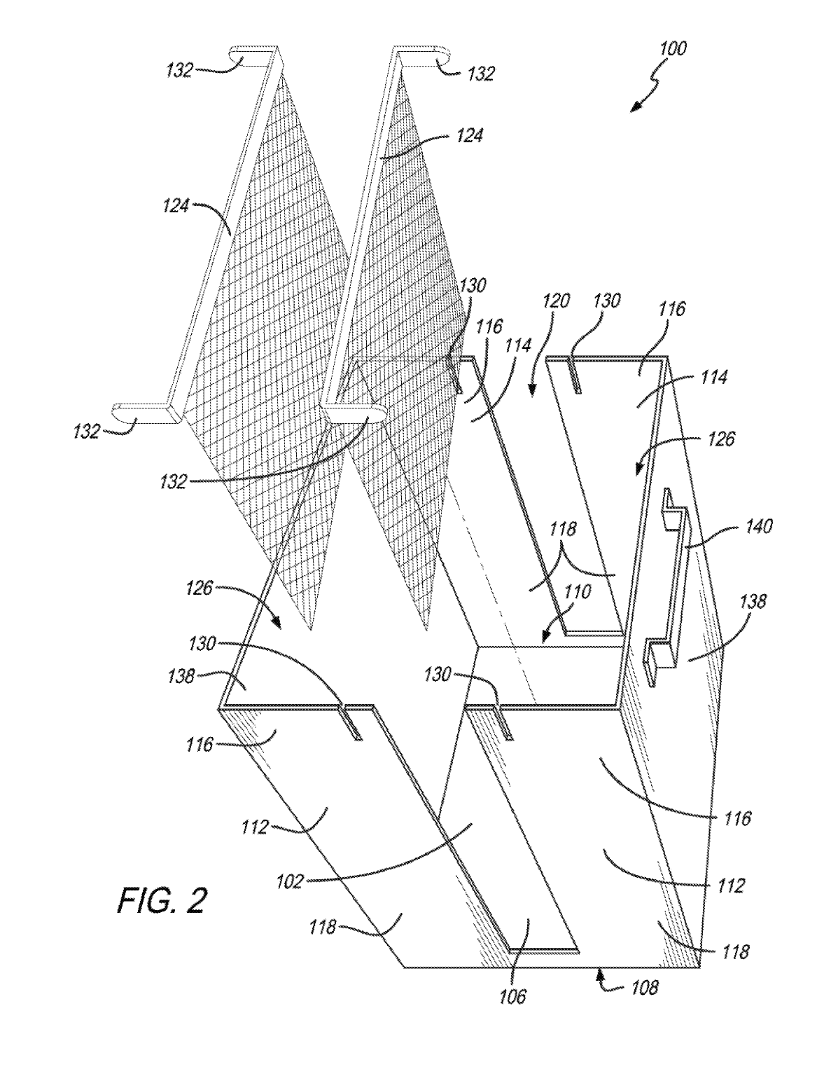

Referring now to FIGS. 1 and 2, there is shown a vertical barbeque grill 100 comprising a base 102 comprising a bottom surface 104, a top surface 106, a proximate edge 108 and a distal edge 110, at least two pairs of supports 112, 114, which can comprise a first support 112 and a second support 114, the pairs of supports 112, 114 comprising an upper portion 116 and a lower portion 118, wherein the lower portion 118 is coupled to the top surface 106 of the base 102 and the pairs of supports 112, 114 extend away from and are perpendicular to the top surface 106 of the base 102, wherein the first support 112 is coupled to the proximate edge 108 of the base 102 and the second support 114 is coupled to the distal edge 110 of the base 102, the first pair of supports 112, 114 is spaced apart from the second pair of supports 112, 114 at least one cooking chamber 120 disposed in between the two pairs of supports 112, 114, at least one opening 122 in the base 102 below the at least one cooking chamber 120, at least two fire material retaining means 126 coupled to the at least two pairs of supports 112, 114 creating at least two fire material chambers 126, and at least one liquid collection container 128 located below the at least one opening 122 in the base 102.

The base 102 has a top surface 106, a bottom surface 104, a proximate edge 108 and a distal edge 110. The base 102 can be made from any material, but preferably is made from metal that can withstand high temperatures. The metal can comprise steel, stainless steel, mild steel, expanded steel, porcelain coated steel, cast iron, or porcelain coated cast iron. The base 102 can be any dimension but preferably is rectangular and about 12 inches wide and between 10.5 and 25 inches long. The cross section of the base 102 can be any shape, but preferably is rectangular.

The at least two pairs of supports 112, 114 have an upper portion 116 and a lower portion 118. The lower portion 118 of the supports 112, 114 couple to the base 102 and the upper portion 116 of the supports 112, 114 extend vertically away from and perpendicular to the top surface 106 of the base 102. The supports 112, 114 can be made from any material, but preferably are made from metal that can withstand high temperatures. The metal can comprise steel, stainless steel, mild steel, expanded steel, porcelain coated steel, cast iron, or porcelain coated cast iron. The supports 112, 114 can be any shape and any dimension, but preferably are rectangular or square sheets, and are about 4.5 to 5 inches wide and approximately 12 inches tall. Optionally, the supports 112, 114 are not solid sheets of metal, but instead comprise one or more vertically extending rods (not shown) to provide the necessary support. The at least two pairs of supports 112, 114 are spaced apart from each other such that there is a space in between. The distance between the at least two pairs of supports 112, 114 can be any distance, but preferably is about 1 to 2 inches. Additionally, the upper portion 116 of the supports 112, 114 can comprise one or more slots 130 for the fire material retaining means 124 to couple to, thereby supporting the fire material retaining means 124.

The cooking chamber 120 is located in between the two pairs of supports 112, 114 and is where the food is placed that is to be cooked. The cooking chamber 120 can be any shape and any dimension, but preferably is about 1.5 inches wide, 12 inches long and 12 inches high. Optionally, the user can insert a grilling basket (not shown) into the cooking chamber 120. Typical grilling baskets comprise a metal cage that the food is placed inside. Due to the substantially open structure of the grilling basket, the food is quickly cooked. Such a grilling basket can be utilized in the present invention, but it is not necessary. Optionally, the cooking chamber 120 can comprise a lid (not shown), which will aid in heat retention and help speed up cooking time. The lid can be either solid or comprise a mesh.

Additionally, the at least two pairs of supports 112, 114 can further comprise a plurality of tabs 142, that extend from the supports 112, 114 into the cooking chamber 120. The plurality of tabs 142 support the grilling basket, holding it securely in place. Additionally, because the plurality of tabs 142 are somewhat flexible, they bend to accommodate different sized grilling baskets. The plurality of tabs 142 can be made from any material, but preferably are made from metal that can withstand high temperatures. The metal can comprise steel, stainless steel, mild steel, expanded steel, porcelain coated steel, cast iron, or porcelain coated cast iron. The plurality of tabs 142 can be any size and dimension, but preferably are approximately 1 inch wide and 1 inch long.

The base 102 can further comprise one or more openings 122 located below the cooking chamber 120. The one or more openings 122 allow liquid that has left the food during cooking to exit the cooking chamber 120. If the one or more openings 122 are not present then the liquid will pool along the base 102 and eventually come into contact with both the food and the charcoal. Not only is this unsanitary, but it will create smoke, both of which are undesirable. The one or more openings 122 also provide the added benefit of producing a healthy low fat cooking method, as any fat that leaves the food is permitted to drain away from the food. The one or more openings 122 can be any shape, including but not limited to circular, square, or rectangular. Additionally, the one or more openings 122 can be any size, but preferably are about 0.25 inches in diameter.

The at least two fire material retaining means 126 can be made from any material, but preferably are made from metal that can withstand high temperatures. The metal can comprise steel, stainless steel, mild steel, expanded steel, porcelain coated steel, cast iron, or porcelain coated cast iron. The fire material retaining means 126 can be in any form, including but not limited to a plurality of rods or a mesh. Preferably the fire material retaining means 126 comprise a mesh. Additionally, the fire material retaining means 126 can further comprise a first set of one or more tabs 132 that extend from the fire material retaining means 126 and can be inserted into the slots 130 in the upper portions of the supports 112, 114.

Coupling the one or more fire material retaining means 126 to the supports 112, 114 creates one or more fire material chambers 126. The fire material chambers 126 hold the material that will be used to make fire and cook the food in the cooking chamber 120. Any fire material can be used, including but not limited to natural briquettes, composition briquettes, charwood, lump charcoal, charcoal briquettes, wood, wood logs, wood chips, wood chunks, paper material, Preferably there are at least two fire material chambers 126, one on either side of the cooking chamber 120, which results in the food being cooked from both sides at the same time. This is extremely beneficial because it not only reduces cooking time but also removes the need to flip the food, as required by a typical barbeque grill. Additionally, the reduced cooking time helps maintain meat tenderness.

The fire material chambers 126 can be removable, via either the fire material retaining means 126 being removable or the fire material chambers 126 being comprised of an independent cage-like structure which can be inserted between the pairs of supports 112, 114. Optionally, the fire material chambers 126 can be permanently coupled to the base 102. The fire material chambers 126 can be any shape and size, but preferably are in the shape of a rectangular parallelepiped and are approximately 4-5 inches wide, 12 inches long and 12 inches tall. An added benefit of the vertical orientation of the fire material chambers 126 is that there is a reduction in charcoal prep time as well as the amount of charcoal needed to cook the food. This results in time and cost savings for the user.

Additionally, the first support 112 can be coupled to the second support 114 by a connecting wall 138, which creates the third wall of the fire material chamber 126. As shown in the Figures, the end units of the fire material chambers 126 are created by a first support 112, a second support 114, one fire material retaining means 126 and a connecting wall 138. The connecting wall 138 helps keep the heat within the fire material chambers 126 and decreases cooking time. Optionally, the connecting wall 138 can comprise one or more handles 140 coupled to the connecting wall 138, to aid the user in moving the vertical barbeque grill 100 from one location to another.

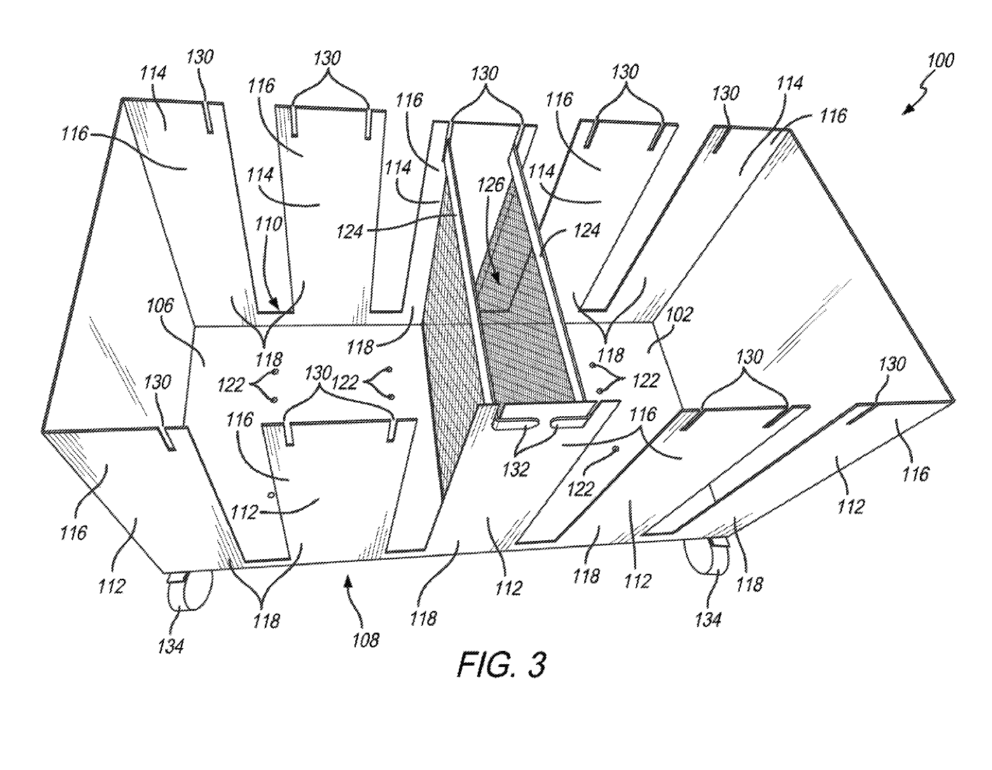

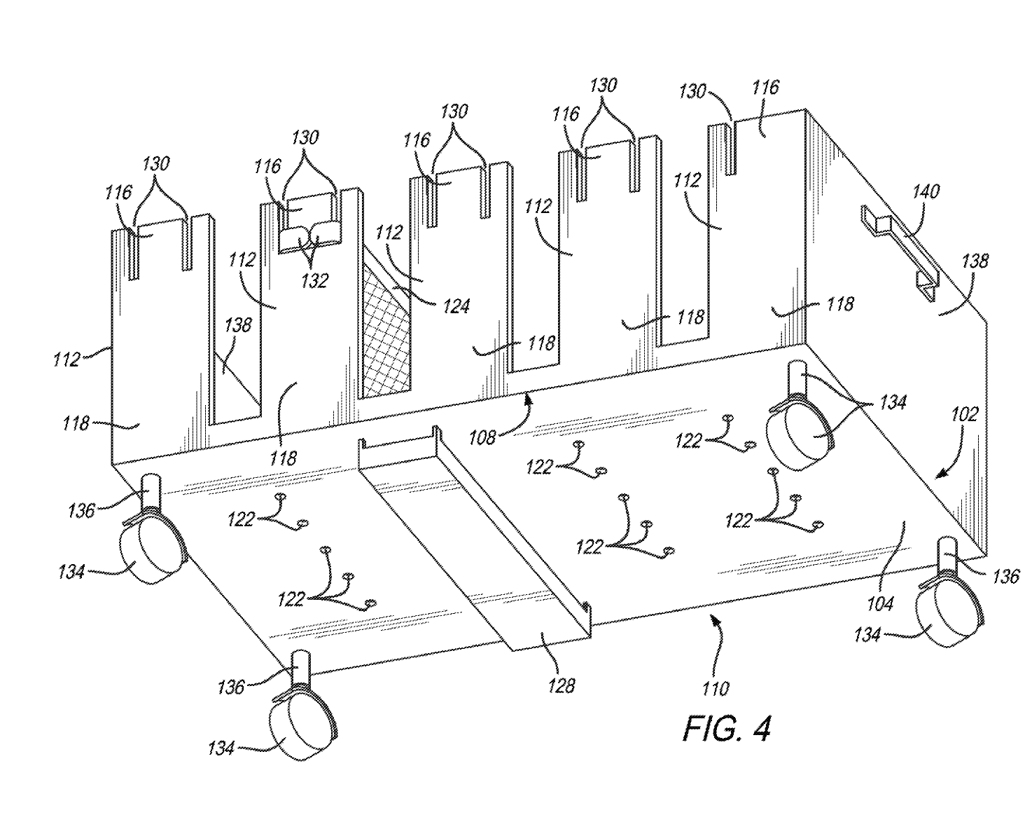

Referring now to FIGS. 3 and 4, the vertical barbeque grill 100 can comprise multiple fire material chambers 126 and cooking chambers 120 coupled together. In this embodiment, each fire material chamber 126 created in the middle of the vertical barbeque grill 100 is created by a first support 112, a second support 114, and two fire material retaining means 126.

Additionally, the vertical barbeque grill 100 can further comprise one or more liquid collection containers 128 located below the one or more openings 122 in the base 102. The purpose of the liquid collection containers 128 is to collect the liquid that is released from the food when it cooks. Many people desire to make gravy and other condiments using the liquid that is released from the food, and the liquid collection containers 128 provide an easy to use and sanitary means to collect and reuse the liquid. The liquid collection container 128 can be in the form of a single large tray that underlies the entire base 102 and all of the cooking chambers 120 simultaneously, or the liquid collection container 128 can comprise multiple individual liquid collection containers 128, wherein a single liquid collection container 128 is placed below each cooking chamber 120. This would be desirable if different types of meat were being cooked at the same time but there was a need to keep the liquids released from each type separate. Additionally, collecting the liquid in the one or more liquid collection containers 128 makes the vertical barbeque grill 100 easier to clean and keep clean.

Optionally, the vertical barbeque grill 100 can further comprise one or more wheels 134 coupled to the bottom surface 104 of the base 102. The wheels 134 can be any distance from the base 102, and be either directly coupled to the base 102 or coupled to the base 102 by one or more legs 136. The legs 136 can be any length, but preferably are about 24 inches long. Optionally, the legs 136 can be adjustable so that the height of the vertical barbeque grill 100 can be easily adjusted. Preferably the wheels 134 are about 2 to 3 feet from the base 102 so that when in use, the vertical barbeque grill 100 is approximately waist-height with respect to the user so that the vertical barbeque grill 100 is convenient and easy to use.

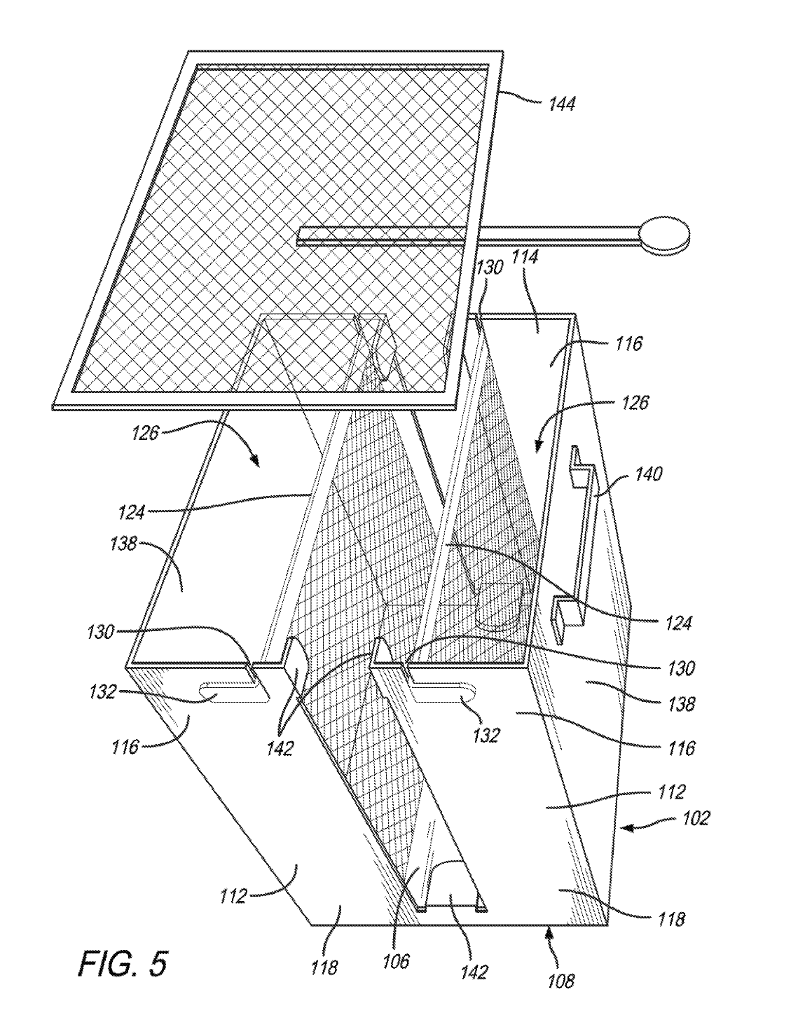

Referring now to FIG. 5, the vertical barbeque grill 100 can further comprise a searer 144, for searing or cooking food placed on it. The searer 144 is placed on top of the vertical barbeque grill 100, and then a user can place and cook food on top of the searer 144. This is advantageous because it increases the effective cooking area created by the vertical barbeque grill 100. Not only can the user utilize the cooking chambers 120, but the top of the vertical barbeque grill 100 can be turned in a cooking area as well. The searer 144 can be made from any material, but preferably are made from metal that can withstand high temperatures. The metal can comprise steel, stainless steel, mild steel, expanded steel, porcelain coated steel, cast iron, or porcelain coated cast iron. The searer 144 can be any size and dimension, but preferably is approximately 4 inches long and 10 inches wide.

A method of using the vertical barbeque grill 100 comprising the steps of providing the vertical barbeque grill 100, coupling the at least two fire material retaining means to the at least two pairs of supports 112, 114, inserting fire material into the at least two fire material chambers 126, igniting the fire material to produce a heat source for cooking food, inserting food into the cooking chamber 120, and cooking the food inside the cooking chamber 120.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended features should not be limited to the description of preferred embodiments contained in this disclosure. All references cited herein are incorporated by reference in their entirety.

1. (canceled)

2. A vertical barbeque grill comprising:
a) a base comprising a bottom surface, a top surface, a proximate edge and a distal edge;
b) at least two pairs of supports comprising a first support and a second support, the pairs of supports comprising an upper portion and a lower portion, wherein the lower portion is coupled to the top surface of the base and the at least two pairs of supports extend away from and are perpendicular to the top surface of the base, wherein the first support is coupled to the proximate edge of the base and the second support is coupled to the distal edge of the base, the first pair of supports is spaced apart from the second pair of supports;
c) at least one cooking chamber disposed in between the two pairs of supports;
d) at least one opening in the base below the at least one cooking chamber;
e) at least two fire material retaining means coupled to the supports, creating at least two fire material chambers; and
f) at least one liquid collection container located below the at least one opening in the base.

3. A vertical barbeque grill comprising:
a) a base comprising a bottom surface, a top surface, a proximate edge and a distal edge;
b) at least two pairs of supports coupled to the top surface of the base, extending away from and perpendicular to the top surface of the base, wherein the at least two pairs of supports comprise a first support coupled to the proximate edge of the base and a second support coupled to the distal edge of the base, the first pair of supports is spaced apart from the second pair of supports; and
c) at least one cooking chamber disposed in between the two pairs of supports.

4. The vertical barbeque grill of claim 3, wherein the base and the at least two pairs of supports are made from metal.

5. The vertical barbeque grill of claim 3, wherein the at least two pairs of supports comprise a plurality of tabs extending from the supports into the cooking chamber.

6. The vertical barbeque grill of claim 3, further comprising at least one opening in the base below the at least one cooking chamber.

7. The vertical barbeque grill of claim 6, further comprising at least one liquid collection container located below the at least one opening in the bottom surface of the base for collecting liquid released from food in the cooking chamber.

8. The vertical barbeque grill of claim 3, further comprising at least two fire material retaining means coupled to the at least two pairs of supports, creating at least two fire material chambers.

9. The vertical barbeque grill of claim 8, wherein the at least two fire material retaining means are removable.

10. The vertical barbeque grill of claim 8, wherein the at least two fire material retaining means comprise a mesh.

11. The vertical barbeque grill of claim 8, wherein the at least two pairs of supports comprise an upper portion and a lower portion, and the upper portion comprises at least one slot and the at least two fire retaining means are coupled to the upper portion of the supports by the at least one slot.

12. The vertical barbeque grill of claim 3, further comprising at least one liquid collection container located below the cooking chamber.

13. The vertical barbeque grill of claim 3, further comprising a searer.

14. A method of using the vertical barbeque grill of claim 2, the method comprising the steps of:
a) providing the vertical barbeque grill of claim 2;
b) coupling the at least two fire material retaining means to the at least two pairs of supports;
c) inserting fire material into the at least two fire material chambers;
d) igniting the fire material to produce a heat source for cooking food;
e) inserting food into the cooking chamber; and
f) cooking the food inside the cooking chamber.

15. The method of claim 14, wherein the at least two pairs of supports comprise a plurality of tabs extending from the supports into the cooking chamber.

16. The method of claim 14, wherein the vertical barbeque grill further comprises a searer.
